(19) United States
(12) Patent Application Publication
(10) Pub. No.: US 2005/0029771 A1
(43) Pub. Date: Feb. 10, 2005

(54) Two wheel steering bicycle with operator positioned facing sideways whose support frame passes under operator supporting operator unicycle like saddle

(76) Inventor: Michael Killian, Boston, MA (US)

Correspondence Address: MICHAEL KILLIAN, 32 WESTLAND AVE #16, BOSTON, MA, 02115, US

(21) Appl. No.: 10/635,151

(22) Filed: Aug. 6, 2003

(51) Int. Cl. B62K 1/00

(52) U.S. Cl. 280/267

(57) ABSTRACT

A two wheel steering bicycle with latitudinal aligned wheels device. A center support member connects the left head tube to the right head tube and extends substantially underneath the operator. The left wheel attaches to the left fork extending upwards. The left fork steerer column passes through the left head tube and can rotate within the left head tube by means of a bicycle bearing headset. A left steering handle is connected to the left fork steerer column. The left steering handle is designed to contact the rider's hand. The right wheel attaches to the right fork extending upwards. The right fork steerer column passes through the right head tube and can rotate within the right head tube by means of a bicycle bearing headset. A right steering handle is connected to the right fork steerer column. The right steering handle is designed to contact the rider's hand. A rider support member attaches to the center support member extending upward. A unicycle style saddle is attached to the rider support member in such a way as to position the rider facing perpendicular to the longitudinal axis of the center support member. A bicycle bottom bracket, left and right crank and pedals are attached to the bottom of the rider support member. A second crank is attached to the left pedal and transmits power to the left wheel via a universal joint, driveshaft, right angle gearbox and chain and cog set. The rider's left hand is positioned at the user's left side and contacts the left steering handle. The rider's right hand is positioned at the user's right side and contacts the right steering handle. The device moves to either the right or left by pedaling forward or reverse. The saddle and steering handles should be adjusted so that the rider's body is roughly balanced across the vertical plane of the left and right wheels. The device moves to the right or the left and the rider keeps the device balanced by constantly correcting the left and right steering systems. It may take some practice to make this correction reflex, but once mastered this device offers more control and artistic expression than a currently available bicycle.

### FIELD OF THE INVENTION

The present invention relates to bicycles.

### BACKGROUND OF THE INVENTION

The invention relates to bicycles and comprises a support frame and two steerable wheels mounted in a latitudinal direction. More specifically, the present invention relates to bicycles which can be used to traverse smooth and rough terrain including mountain slopes.

Human balance can be considered in two separate axes. Human balance left side to right side and human balance front to back. Left to right human balance is relatively inaccurate; as evidenced by trying to stand on one foot. However since the human body has two feet there is a constant correcting mechanism by moving ones hips and upper body relative to both left and right foot. This endless correction makes left to right balance very useful for walking and standing. Devices based on human left to right balance, like the bicycle tap into this constant correcting mechanism. A bicycle is in a constant state of losing its balance and with the endless correcting of the front wheel it is kept in balance. People learn to ride a bicycle because this constant correcting is much like the person's natural left to right correction mechanism.

Front to back balance is in many ways much more accurate as evidenced by the operation of the ankle and foot as you lean slightly forward. There is none of the left to right instability as when you stand on one foot. The big difference in front to back balance is that it has leverage much closer to the ground for correcting balance; namely the ankle and foot. This means that the balance correction is quicker for front to back balance. One simply has to apply pressure on his/her soles or heels. Rarely is upper body weight shifting involved in front to back balance correction.

Devices that leverage front to back balance include snowboards and to a lesser extent skateboards. In both cases balance is restored by pushing down on ones toes with respect to ones heels or lifting ones toes. This action in a snowboard causes the board to carve into the snow in a forward or rearward direction and thus recovering balance. These actions in a skateboard causes the truck to change the relative orientation of the rear axle with respect to the front axle and turning toward the front or towards the rear and again regaining balance. Snowboards and skateboards traveling at high speed tend to be difficult to control and are better suited to slow speed artistic expression. This is because the length of a person's foot is relatively short when compared with the distance between left and right foot with feet apart.

Devices that leverage left to right balance include currently available bicycles.

U.S. Pat. No. 6,598,892 by this inventor is a precursor to this invention. In this patent the center support member extends between rear and front head tubes. The rider support member connects to the center support member and extends downward.

The present invention discloses a two wheel steering bicycle with latitudinal aligned wheels. This will leverage human front to back balance primarily with left to right balance having only secondary input. A center support member extends between left and right head tubes passing substantially under the rider. A rider support member connects with the center support member and extends upward. This differs from U.S. Pat. No. 6,598,892 by this inventor where the rider support member connects to the center support member and extends downward. The user sits on a unicycle saddle connected to the rider support member and balances the device by continuously correcting the orientation of the left and right wheel with his/her left and right hand respectively. The user's body faces perpendicular to the direction of motion. The unicycle saddle and left and right steering handles should be adjusted to position the user's body to roughly balance the left to right center axis of the device. The unicycle saddle with its raised front and back allows the rider to detect his/her position relating to vertical. The unicycle saddle is also the rider's main contact with the device and the point from where the steering handles are leveraged by the rider's hands.

When the user feels himself/herself falling forward out of balance, the user moves his/her hands in such a way as to bring his/her hands further apart which steers each wheel in such a way as to track the device forward of the original line of motion and thus regaining balance. The user must be in a state of constant correction which with practice will become natural and reflex. This device moves the user in a sideways direction and can move to the right or left. Some embodiments of the device will be bi-directional where direction is changed by reversing the pedal direction or by a gearbox or by other means. Preferably the means of propelling the device is a regular bicycle front crank and pedals driving a shaft which inputs a 90 degree gearbox which drives a chain to the wheel. The device could also be configured with a sheathed cable drive system or other drive systems. Propelling the device requires actions similar to a regular bicycle. The user moves the pedals in a circular motion which drives the wheel. Once the user has mastered the basics of propulsion and turning the user can start introducing his/her weight into the turns by leaning into the turns. The feedback from this device is strongest when the user uses his/her weight. It is expected that this invention will excel at carving turns and will work best on open paved areas or grass slopes. It is expected that this invention will be more expressive than a regular bicycle and will reward the operator with much positive feedback of having mastered his/her balance.

### SUMMARY OF THE INVENTION

It is an object of the present invention to provide a two wheel steering bicycle with latitudinal aligned wheels. It is a more particular object of the invention to provide a center support member that extends substantially under the rider. It is a more particular object of the invention to provide a rider support member that connects to the center support member and extends upward. It is a more particular object of the invention to provide a unicycle saddle and drive mechanism. The unicycle saddle positions the rider perpendicular to the longitudinal axis of the center support member.

It is an object of the present invention to provide right and left head tubes attached to each end of the center support member.

It is an object of the present invention to provide right and left wheels supported by forks whose steerer columns extend through respective bicycle headsets and right and left head tubes.

Each fork steerer column attaches to an associated steering handle.

Each steering handle includes means of contact with the user's hand.

### DESCRIPTION OF THE DRAWINGS

These and other aspects of the present invention will become more evident upon reading the following description of the preferred embodiment in conjunction with the accompanying drawings, in which:

FIG. 1 is a side view of the current invention where the rider's back would be visible.

FIG. 2 is a left view of a portion of the current invention detailing the left wheel, left fork, left head tube, left headset and left steering handle.

FIG. 3 is a side view of a portion of the current invention detailing the center support member; rider support member; unicycle saddle and drive mechanism.

FIG. 4 is a side view of a portion of the current invention where the operator's front would be visible, detailing the drive system.

FIG. 5 is a side view of a user riding the current invention where the user's back is visible.

FIG. 6 is a left view of a user riding the current invention where the user's left side is visible.

### DETAILED DESCRIPTION OF PREFERRED EMBODIMENTS

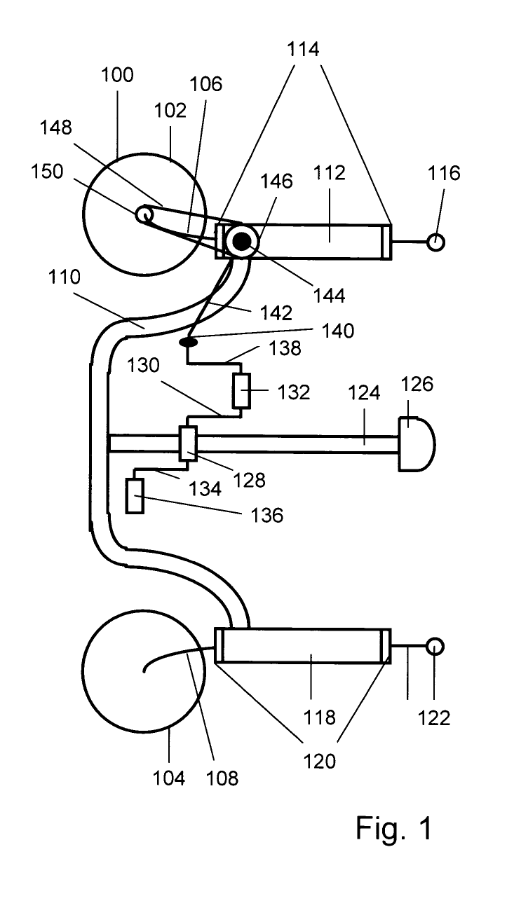

FIG. 1 illustrates the current invention 100. In FIG. 1 left wheel 102 and right wheel 104 support left fork 106 and right fork 108 respectively from the ground. Center support member 110 connects to left head tube 112 and right head tube 114. The steerer column of left fork 106 extends through left headset 114 and left head tube 112 to connect with left steering handle 116. The steerer column of right fork 108 extends through right headset 120 and right head tube 118 to connect with right steering handle 122. Rider support member 124 connects to center support member 110. Unicycle saddle 126 connects to rider support member 124. Bicycle bottom bracket 128 connects to rider support member 124.

Bicycle left crank 130 and left pedal 132 connect to the left side of bicycle bottom bracket 128. Bicycle right crank 134 and right pedal 136 connect to the right side of bicycle bottom bracket 128. Bicycle crank 138 connects to left pedal 132 and to universal joint 140. Drive shaft 142 connects to universal joint 140 and right angle gearbox 144. Right angle gearbox drives cog 146. Chain 148 transfers power between cog 146 and wheel cog 150.

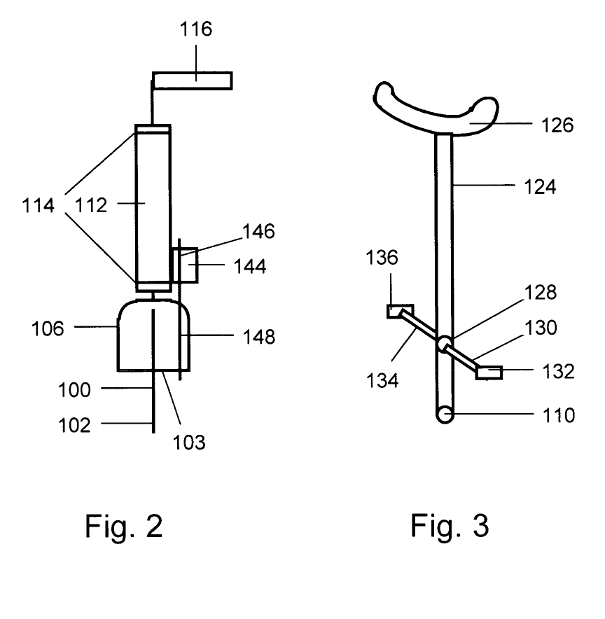

FIG. 2 is a left view of a portion of the current invention 100. In FIG. 2 left wheel 102 is connected to left fork 106 at axle 103. The steerer column of left fork 106 extends through left headset 114 and left head tube 112 to left steering handle 116. Right angle gearbox 144 drives output cog 146 which drives chain 148.

FIG. 3 is a left view of a portion of the current invention 100 detailing the rider support member 124. In FIG. 3 the rider support member 124 is connected to center support member 110. Unicycle saddle 126 is connected to rider support member 124. Bicycle left crank 130 and left pedal 132 connect to the left side of bicycle bottom bracket 128. Right crank 134 and right pedal 136 connect to the right side of bicycle bottom bracket 128.

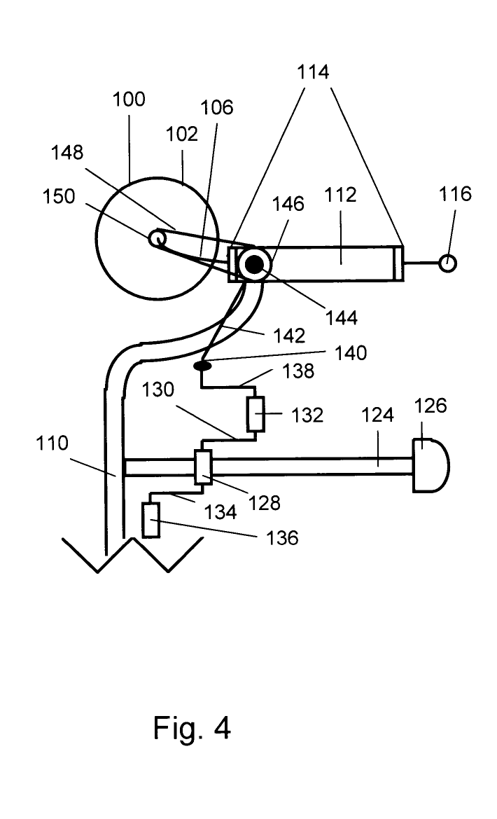

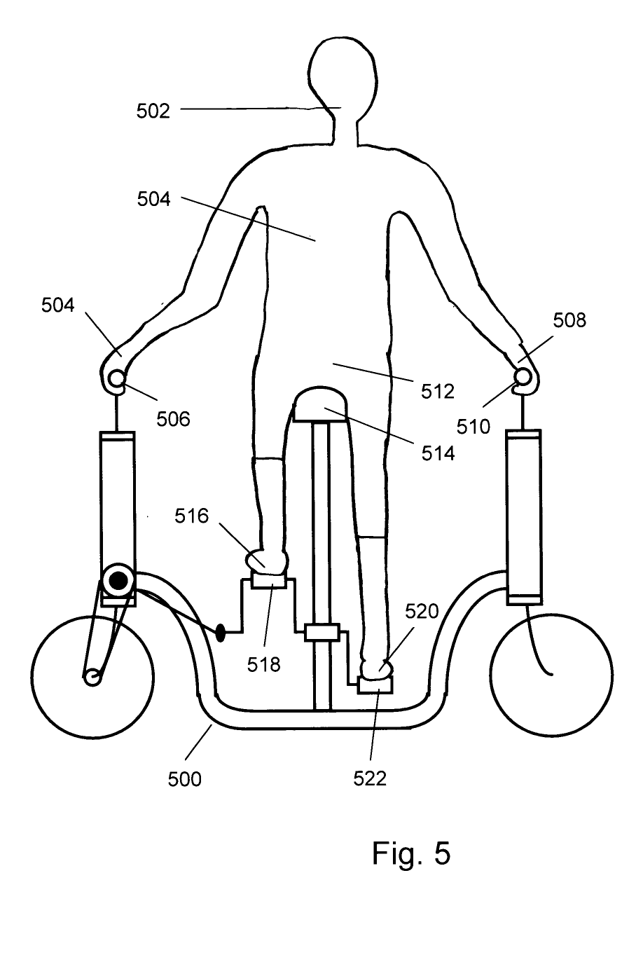

FIG. 4 illustrates a portion of the current invention 100 which illustrates the drive chain routing. In FIG. 4 left wheel 102 supports left fork 106 from the ground The steerer column of left fork 106 extends through left headset 114 and left head tube 112 to connect with left steering handle 116. Rider support member 124 connects to center support member 110. Unicycle saddle 126 connects to rider support member 124.

Bicycle bottom bracket 128 connects to rider support member 124. Bicycle left crank 130 and left pedal 132 connect to the left side of bicycle bottom bracket 128. Bicycle right crank 134 and right pedal 136 connect to the right side of bicycle bottom bracket 128. Bicycle crank 138 connects to left pedal 132 and to universal joint 140. Drive shaft 142 connects to universal joint 140 and right angle gearbox 144. Right angle gearbox drives cog 146. Chain 148 transfers power between cog 146 and left wheel cog 150.

FIG. 5 illustrates a rider 502 riding the current invention 500. In FIG. 5 the rider's back 503 is illustrated. The rider's left hand 504 grips the left steering handle forearm member 506. The rider's right hand 508 grips the right steering handle 510. The rider's seat 512 rests on unicycle saddle 514. The rider's left foot 516 is positioned on the left pedal 518 of the invention 500. The rider's right foot 518 is positioned on the right pedal 520 of the invention 500.

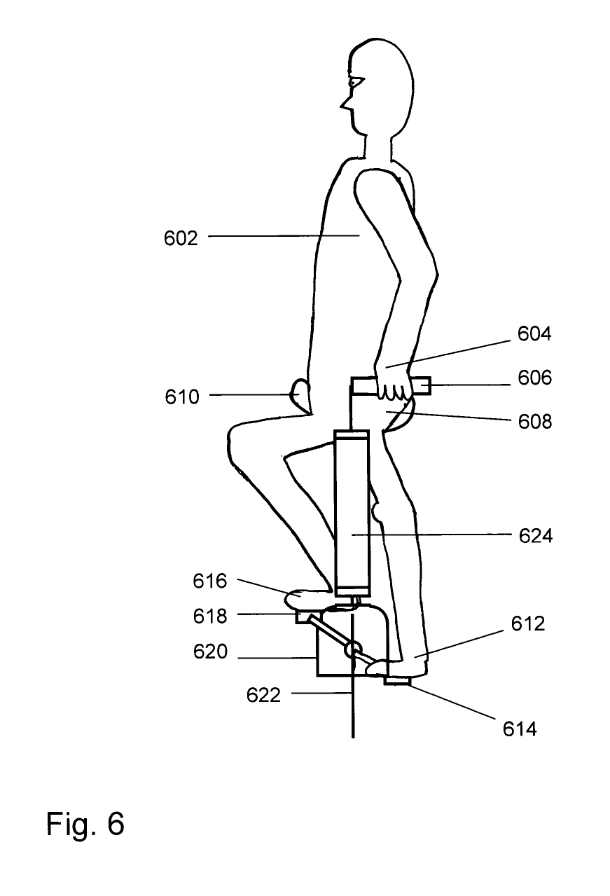

FIG. 6 illustrates the side view of rider 602 riding the current invention 600. In FIG. 6 the rider's left side is illustrated. The rider's left hand 604 grips the left steering handle 606. The rider's seat 608 rests on unicycle saddle 610. The rider's left foot 612 is positioned on the left pedal 614. The rider's right foot 616 is positioned on the right pedal 618. Left fork 620, left wheel 622 and left head tube 624 are also illustrated. It should be noted that rider 602 is roughly balanced across the plane of left wheel 622.

### Additional Features

In view of the wide variety of embodiments to which the principles of the invention can be applied, it should be apparent that the detailed description of a preferred embodiment is illustrative only and should not be taken as limiting the scope of the invention. For example power could be transmitted to the device using a wide variety of linkages and levers could be used instead of the rotational pedal mechanism illustrated.

Also, the principles of the present invention work equally well whether the vehicle is self-propelled, rider-propelled, gravity propelled, or propelled by other sources, such as wind. Accordingly, the vehicle of the present invention could readily include forms of propulsion, such as a motor, sail or other forms of propulsion without compromising the principles of the present invention.

1. A two wheel steering bicycle comprising:
a center support member that passes substantially under the rider;
a left head tube member connected to said center support member;
a left headset member;
a right head tube member connected to said center support member;
a right headset member;
a left fork member that extends upward with said fork member steerer column pivotably mounted within said left head tube member using said left headset member;
a single left wheel being rototably mounted on said left fork member;
a right fork member that extends upward with said fork member steerer column pivotably mounted within said right head tube member using said right headset member;
a single right wheel being rototably mounted on said right fork member;
a left steering member connected to said left fork member;
a right steering member connected to said right fork member;
a rider support member connected to the said center support member and extending upward;
a saddle connected to said rider support member wherein:
said saddle orients the rider facing perpendicular to the vertical plane intersecting the center of
said left head tube member and said right head tube member;
a pedal mechanism connected to said rider support member including means of transferring rotational energy from said pedal mechanism to one of said wheels.

2. The two wheel steering bicycle according to claim 1, wherein said saddle is a unicycle saddle.

3. The two wheel steering bicycle according to claim 2, wherein said pedal mechanism include:
chain, cogs and right angle gearbox for transferring rotational energy from said pedal mechanism to one of said wheels.

4. A two wheel steering bicycle with rider mounted upright facing perpendicular to the direction of motion comprising:
a center support member that passes substantially under the rider;
a left head tube member connected to said center support member;
a left headset member;
a right head tube member connected to said center support member;
a right headset member;
a left fork member that extends upward with said fork member steerer column pivotably mounted within said left head tube member using said left headset member;
a single left wheel being rototably mounted on said left fork member;
a right fork member that extends upward with said fork member steerer column pivotably mounted within said right head tube member using said right headset member;
a single right wheel being rototably mounted on said right fork member;
a left steering member connected to said left fork member;
a right steering member connected to said right fork member;
a rider support member connected to the said center support member and extending upward;
a saddle connected to said rider support member.

5. The two wheel steering bicycle according to claim 4, wherein said saddle is a unicycle saddle.
